(19) United States
(12) Patent Application Publication
(10) Pub. No.: US 2007/0026350 A1
(43) Pub. Date: Feb. 1, 2007

(54) Glassware mold lubrication system

(76) Inventors: Garrett L. Scott, Toledo, OH (US); Jacques Buthion, Villette de Vienne (FR); Pascal Lemasson, Saint-Andeol le Chateau (FR)

Correspondence Address: OWENS-ILLINOIS, INC., ONE MICHAEL OWENS WAY, THREE O-I PLAZA, PERRYSBURG, OH, 43551-2999, US

(21) Appl. No.: 11/190,366

(22) Filed: Jul. 27, 2005

(51) Int. Cl. F23Q 2/08; C03B 40/02; C03B 40/027

(52) U.S. Cl. 431/132; 65/26; 65/170

(57) ABSTRACT

A system for lubricating a glassware mold surface includes a glassware mold having an open end, a burner for providing a combustible carbon-containing gas, and at least one electrode to ignite a flame from the combustible gas directed toward the open end of the mold. The at least one electrode is carried by the burner so as to be surrounded by the gas stream and the flame ignited from the gas stream. The burner preferably has an array of gas outlet ports, and the electrode preferably is mounted on the burner so as to be surrounded by the ports.

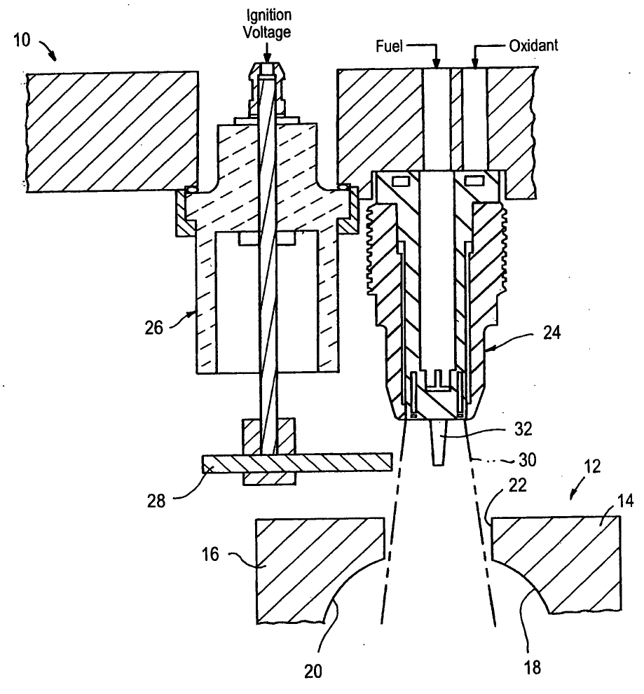

The present disclosure relates to spark-ignition of combustible carbon-containing gas for lubricating the glass-contacting surfaces of a glassware forming mold.

### BACKGROUND AND SUMMARY OF THE DISCLOSURE

U.S. patent document 2003/0221455A1 discloses a system for flame-deposition of carbon onto the glass-contacting surfaces of a glassware forming mold. A combustible carbon-containing gas is directed by a burner toward the open end of a glassware mold. A pair of spark electrodes, including an ignition electrode and a ground electrode, are spaced from each other and disposed within the gas stream emerging from the burner. The electrodes are energized to ignite the carbon-containing gas and form a flame that precipitates electrically conductive carbon particles on the surfaces of the mold. However, immersion of the electrodes in the flame path makes the electrodes susceptible to carbon buildup. Furthermore, the electrodes can deflect or alter the flame pattern, particularly as carbon builds up on the electrodes, resulting in less than optimum carbon deposition on the mold surfaces. It is a general object of the present invention to provide a glassware mold lubrication system and method that reduce or eliminate carbon deposition on at least the spark ignition electrode, and that do not affect the flame pattern of the ignited carbon-containing gas.

The present disclosure embodies a number of aspects or inventions that can be implemented separately from or in combination with each other.

A system for lubricating a glassware mold surface, in accordance with one aspect of the present disclosure, includes a glassware mold having an open end, a burner for providing a combustible carbon-containing gas, and at least one electrode to ignite a flame from the combustible gas directed toward the open end of the mold. (The term “combustible carbon-containing gas” includes gas mixtures, such as mixtures that include a carbonaceous fuel and an oxidant.) The at least one electrode is carried by the burner so as to be surrounded by the gas stream. The burner preferably has an array of gas outlet ports, and the ground electrode preferably is mounted on the burner so as to be surrounded by the ports.

A system for lubricating a glassware mold surface, in accordance with another aspect of the present disclosure, includes a glassware mold having an open end, a burner for providing a combustible carbon-containing gas, and a pair of spark electrodes to ignite a flame from the combustible gas directed toward the open end of the mold. The pair of electrodes includes a ground electrode carried by the burner so as to be surrounded by the gas stream and the flame ignited from the gas stream, and an ignition electrode positioned outside of the gas stream and flame. The burner preferably has an array of gas outlet ports, and the ground electrode preferably is mounted on the burner so as to be surrounded by the ports. The ignition electrode preferably is laterally offset from the ground electrode.

### BRIEF DESCRIPTION OF THE DRAWING

The disclosure, together with additional objects, features, advantages and aspects thereof, will best be understood from the following description, the appended claims and the accompanying drawing, which is a schematic diagram of a system for lubricating a glassware mold in accordance with an exemplary embodiment of the present disclosure.

### DETAILED DESCRIPTION OF PREFERRED EMBODIMENTS

The disclosures of U.S. patent document 2003/0221455A1 and U.S. Pat. application Ser. No. 10/855,830 are incorporated herein by reference.

The drawing illustrates a system 10 for lubricating the glass-contacting surfaces of a glassware forming mold 12. Mold 12 is illustrated as including a pair of mold sections 14,16 having respective glass-contacting surfaces 18,20. Mold 12 has an open end 22 that is aligned with a gas burner 24. (It will be appreciated that burner 24 and system 10 are moved into and out of alignment with open mold end 22 during operation of the glassware forming system.) Burner 24 receives input, such as fuel and oxidant, to form a combustible carbonaceous gas that is directed toward mold open end 22. Burner 24 preferably is as disclosed in above-noted U.S. patent document 2003/0221455A1, and includes an annular array of gas outlet ports, preferably with fuel and oxidant ports alternating with each other. The fuel and oxidant that emerge from burner 24 are directed as a mixture toward the open end of the mold.

In the exemplary embodiment illustrated in the drawing, a spark ignition electrode assembly 26 is disposed laterally adjacent to burner 24. Spark ignition electrode 26 may be as disclosed in above-noted U.S. Pat. application Ser. No. 10/855,830, and includes an ignition electrode 28 having a tip disposed adjacent to the tip of burner 24. However, as illustrated in the drawing, the tip of ignition electrode 28 preferably is positioned in this embodiment so as to be outside of the stream 30 of the gas (or gas mixture) that emerges from the tip of burner 24. A ground electrode 32 is carried at the tip of burner 24 so as to be laterally spaced from the tip of ignition electrode 28. In the exemplary embodiment, ground electrode 32 preferably is centered within combustible gas stream 30 that emerges from the burner tip. The combustible gas stream is ignited by application of ignition voltage to electrode assembly 26, which cooperates with ground electrode 32 to ignite the gas stream that emerges from the burner tip.

The system illustrated in the drawing minimizes carbon buildup on the electrodes by optimizing placement of the electrodes. The system also optimizes ignition of gas stream 30 by placement of the spark in a zone most conducive to reliable ignition in the least amount of time after the gas and spark are turned on. The ground electrode is disposed within gas stream 30, preferably centered within the gas stream, and is surrounded by the multiple gas openings in burner 24. Spark ignition 28 is positioned outside of the burner flame. When the fuel gas is a MAPP gas, the burner tip causes the center of the flame to be oxygen-rich, which minimizes or eliminates carbon buildup on the ground electrode. Inasmuch as the ignition electrode is positioned outside of the flame, carbon buildup is minimized or eliminated on this electrode as well. When the fuel gas is acetylene, ground electrode 32 can become coated with carbon. However, the ground electrode is an easy target for automatic cleaning with compressed air, as illustrated in the above-noted patent document.

The ignition system design of the present disclosure improves the reliability of gas ignition by having the spark between electrodes 28,32 pass completely through the gas-to-air interface, allowing the spark to ignite the gas mixture in the most favorable condition. This is to be contrasted with systems in which the spark gap is centered within the gas stream, in which the spark may not encounter an ideal mixture of fuel with oxidant for highly reliable ignition. By having the spark traverse across the outer edge of the gas stream to the center of the stream, the spark encounters all combinations of gas mixture and reliable ignition is ensured. The ignition system of the present disclosure also eliminates the need for two-stage ignition in acetylene fuel systems.

The present disclosure thus provides a system and method for lubricating glassware molds, which fully satisfy all of the objects and aims previously set forth. The disclosure has been presented in conjunction with an exemplary presently preferred embodiment, and various modification and variations have been discussed. Other modifications and variations readily will suggest themselves to persons of ordinary skill in the art in view of the foregoing description. The disclosure is intended to embrace all such modifications and variations as fall within the spirit and broad scope of the appended claims.

1. A system for lubricating a glassware mold surface, which includes a glassware mold having an open end, a burner for providing a combustible carbon-containing gas, and a pair of spark electrodes to ignite a flame from the combustible gas directed toward said open end of said mold,
characterized in that said pair of electrodes includes a ground electrode carried by said burner so as to be surrounded by the flame and an ignition electrode positioned outside of the flame.

2. The system set forth in claim 1 wherein said burner has a tip with an array of gas outlet ports, and wherein said ground electrode is carried by said tip surrounded by said ports.

3. The system set forth in claim 2 wherein said ignition electrode is laterally offset from said ground electrode.

4. A system for lubricating a glassware mold, which includes:
a burner for directing a combustible carbon-containing gas toward the glassware mold through an array of gas outlet ports at a tip of said burner,
a ground electrode carried by said burner tip and extending from said burner tip at a position surrounded by said ports, and
a flame ignition electrode laterally spaced from said ground electrode at a position outside of the path of gas emerging from said burner tip.

5. A method of lubricating glassware molds by flame-deposition of carbon on the mold surfaces, which includes the steps of:
(a) providing a combustible carbon-containing gas stream,
(b) providing a ground electrode within said stream,
(c) providing an ignition electrode laterally spaced from said ground electrode at a position outside of the gas stream, and
(d) igniting said gas stream by means of a spark between said electrodes.

6. A system for lubricating a glassware mold surface, which includes a glassware mold having an open end, a burner for providing a combustible carbon-containing gas, and at least one electrode to ignite a flame from the combustible gas directed toward said open end of said mold,
characterized in that said at least one electrode is carried by said burner so as to be surrounded by the flame.

7. The system set forth in claim 6 wherein said burner has a tip with an array of gas outlet ports, and wherein said at least one electrode is carried by said tip surrounded by said ports.
